(19) United States
(12) Patent Application Publication
(10) Pub. No.: US 2016/0204447 A1
(43) Pub. Date: Jul. 14, 2016

(54) MEMBRANE ELECTRODE ASSEMBLY WITH MULTI-LAYER CATALYST

(71) Applicant: Nissan North America, Inc., Franklin, TN (US)

(72) Inventors: Nilesh Dale, Novi, MI (US); Kan Huang, Farmington Hills, MI (US); Ellazar Niangar, Redford, MI (US); Dianne Atienza, Farmington Hills, MI (US)

(21) Appl. No.: 14/592,181

(22) Filed: Jan. 8, 2015

(51) Int. Cl. H01M 4/90; H01M 4/92; H01M 8/10; H01M 4/86

(52) U.S. Cl. CPC H01M 4/9075; H01M 4/8663; H01M 4/925; H01M 8/1002

(57) ABSTRACT

A membrane electrode assembly includes a membrane, a first layer contacting the membrane and consisting essentially of catalyst particles comprising non-carbon metal oxide support particles and precious metal particles deposited on the non-carbon metal oxide support particles, a second layer of carbon particles on the first layer and a gas diffusion layer in contact with the second layer.

### TECHNICAL FIELD

This disclosure relates to a membrane electrode assembly with a multi-layer catalyst structure, and in particular, to a titanium-ruthenium oxide catalyst layer and a carbon layer.

### BACKGROUND

Carbon has traditionally been the most common material of choice for polymer electrolyte fuel cell (PEFC) electrocatalyst supports due to its low cost, high abundance, high electronic conductivity, and high Brunauer, Emmett, and Teller (BET) surface area, which permits good dispersion of platinum (Pt) active catalyst particles. However, the instability of the carbon-supported platinum electrocatalyst due at least in part to carbon corrosion is a key issue that currently precludes widespread commercialization of PEFCs for automotive applications.

The adverse consequences of carbon corrosion include (i) platinum nanoparticle agglomeration/detachment; (ii) macroscopic electrode thinning/loss of porosity in the electrode; and (iii) enhanced hydrophilicity of the remaining support surface. The first results in loss of catalyst active surface area and lower mass activity resulting from reduced platinum utilization, whereas the second and third result in a lower capacity to hold water and enhanced flooding, leading to severe condensed-phase mass transport limitations. Clearly, both consequences directly impact PEFC cost and performance, especially in the context of automotive stacks.

To address the issues with carbon-based catalyst, non-carbon alternatives are being investigated. However, other disadvantages are present when non-carbon alternatives are used.

### SUMMARY

Embodiments of a membrane electrode assembly are disclosed. One embodiment of a membrane electrode assembly comprises a membrane, a first layer contacting the membrane and consisting essentially of catalyst particles comprising non-carbon metal oxide support particles and precious metal particles deposited on the non-carbon metal oxide support particles, a second layer of carbon particles on the first layer and a gas diffusion layer in contact with the second layer.

Also disclosed are embodiments of a composite catalyst for a membrane electrode assembly. One embodiment comprises a first layer configured to contact a membrane of the membrane electrode assembly, the first layer consisting essentially of catalyst particles comprising non-carbon metal oxide support particles of titanium dioxide and oxides of ruthenium, and precious metal particles deposited on the non-carbon metal oxide support particles and a second layer contacting the first layer and configured to be positioned between the first layer and a gas diffusion layer of the membrane electrode assembly, the second layer comprising carbon particles.

These and other aspects of the present disclosure are disclosed in the following detailed description of the embodiments, the appended claims and the accompanying figures.

### BRIEF DESCRIPTION OF THE DRAWINGS

The various features, advantages and other uses of the present apparatus will become more apparent by referring to the following detailed description and drawing in which:

FIG. 1 is a schematic illustrating an embodiment of the composite electrocatalyst as disclosed herein;

FIG. 2 is a flow diagram of an example method of preparing a composite electrocatalyst as disclosed herein; and

FIG. 3 is a schematic of a fuel cell using the composite electrocatalyst as disclosed herein.

### DETAILED DESCRIPTION

A viable alternative non-carbon support should possess high surface area and electron conductivity, in addition to being highly corrosion resistant across the anticipated potential/pH window. Certain non-carbon metal oxide catalyst supports meet these criteria.

One example of a non-carbon metal oxide catalyst support consists essentially of a non-conductive metal oxide such as titanium dioxide. Titanium dioxide (TiO₂) has very good chemical stability in acidic and oxidative environments. However, titanium dioxide is a semiconductor and its electron conductivity is very low. Substoichiometric titanium oxides (Ti₂O₃, Ti₄O₇, Magnéli phases) obtained by heat treatment of TiO₂ in a reducing environment (i.e., hydrogen, carbon) have electron conductivity similar to graphite as a consequence of the presence of oxygen vacancies in the crystalline lattice. However, the heat treatment process reduces the surface area of these materials, precluding the preparation of supported electrocatalysts with good Pt dispersion.

To overcome the deficiencies of the non-conductive metal oxide alone, a non-carbon metal oxide support having both a non-conductive oxide and a conductive oxide have been developed. For example, a non-carbon mixed-metal oxide support of TiO₂ and conductive metal oxides such as oxides of ruthenium have been developed. Oxides of ruthenium include varying ruthenium/oxygen ratios, such as ruthenium dioxide (RuO²) and ruthenium tetroxide (RuO₄). The non-carbon metal oxide support particle consists essentially of titanium dioxide and oxides of ruthenium. The titanium and ruthenium can have a mole ratio ranging between 1:1 and 9:1 in the non-carbon metal oxide support particle, and the particle sizes of the titanium dioxide and the oxides of ruthenium can be substantially equal. Alternatively, the ruthenium based particles can be smaller than the titanium dioxide particles, with the oxides of ruthenium deposited on the titanium dioxide. A precious metal active catalyst particle such as platinum is deposited on the TiO₂—RuO₂ support.

TiO₂—RuO₂based catalyst provides excellent activity while being stable. However, due to the increased activity of the TiO₂—RuO₂based catalyst, less catalyst is required. A required electrode thickness requires a certain amount of the catalyst. Ruthenium is expensive, and using an amount of the TiO₂—RuO₂ based catalyst required to achieve the requisite activity can result in an electrode catalyst layer that is thinner than desired. Using an amount of the TiO₂—RuO₂ based catalyst to achieve the desired thickness can result in using more catalyst than necessary to achieve the desired activity, potentially rendering the catalyst uneconomical.

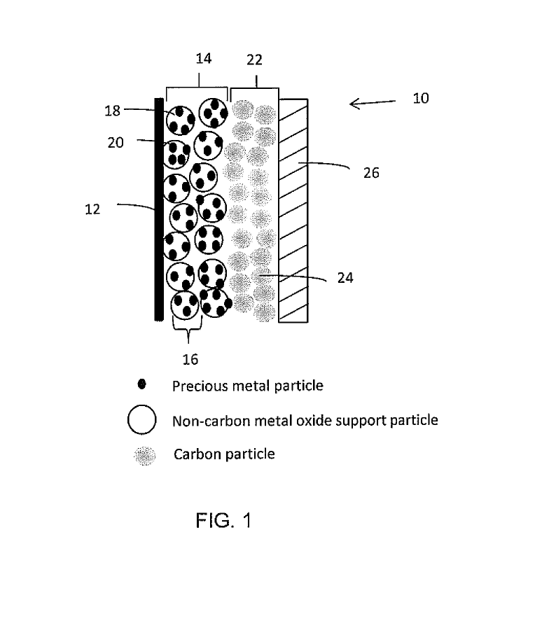

Disclosed herein are embodiments of a composite catalyst and a membrane electrode assembly comprising the composite catalyst. In one embodiment illustrated in FIG. 1, a membrane electrode assembly 10 includes a membrane 12 and a first layer 14 contacting the membrane 12. The first layer 14 consists essentially of catalyst particles 16 comprising non-carbon metal oxide support particles 18 and precious metal particles 20 deposited on the non-carbon metal oxide support particles 18. A second layer 22 of carbon particles 24 is in contact with and between the first layer 14 and a gas diffusion layer 26.

Having the first layer 14 of active catalyst particles 16 near the membrane 12 maintains a stable electrode. Because the precious metal particles 20 are deposited on the non-carbon metal oxide support particles 18 rather than the carbon particles 24, precious metal detachment and agglomeration of the precious metal particles 16 can be prevented. As the fuel cell is used, the carbon particles 24 in the second layer 22 will sacrificially corrode, prolonging the life of the metal oxides used in the first layer 14.

The carbon particles 24 of the second layer 22 can be activated carbon or carbon blacks, such as Vulcan®, Ketjenblack®, Black Pearl™ and acetylene black. Other examples include raw carbon with no structured porosity or carbon precursors, carbon nanotubes, micro-pore controlled structured carbon types. Graphite, graphene, and any other carbon material known to those skilled in the fuel cell catalyst art can also be used.

The carbon material and porosity of the carbon material of the second layer 22 can be selected based on the requirement for water and gas transport, performance and durability. The thickness of the second layer 22 can be selected to optimize the thickness of the electrode while minimizing the use of more costly metal oxides such as ruthenium. The thickness of the first layer 14 can be determined based on catalyst activity requirements, dependent upon the concentration of electroconductive metal oxides in the non-carbon metal oxide support 18, such as ruthenium, and the concentration of the precious metal particles 20. When the thickness of the first layer 14 is optimized, the total thickness of the electrode can be optimized with the second layer 22.

The second layer 22 can also include a binder that can be selected to render the second layer 22 hydrophobic or hydrophilic as desired or required. An ionomer such as Nafion™ or a polytetrafluoroethylene can be mixed with the carbon particles 24 to alter the hydrophilic and hydrophobic properties of the second layer 22.

The precious metal particles 20 can include one or a combination of precious metals such as platinum, gold, rhodium, ruthenium, palladium and iridium, and/or transition metals such as cobalt and nickel. The precious metal can be in various forms, such as alloys, nanowires, nanoparticles and coreshells, which are bimetallic catalysts that possess a base metal core surrounded by a precious metal shell.

The non-carbon metal oxide support particles 18 can be one or more metal oxides prepared with varying ratios of metal oxides and various particle sized depending on the metal oxides used. The non-carbon metal oxide support particles 18 can be nanotubes or core shells.

In one embodiment, the non-carbon metal oxide support particles 18 comprise titanium oxide and oxide of ruthenium. The oxide of ruthenium can be one or both of ruthenium dioxide and ruthenium tetroxide. Other oxides of ruthenium can be used as known to those skilled in the art. The non-carbon metal oxide support particles 18 can also consist essentially of only titanium oxide and an oxide of ruthenium. The oxide of ruthenium can be deposited onto the titanium oxide to form the non-carbon metal oxide support particles. The particle diameter of the oxide of ruthenium can be smaller than the particle diameter of the titanium oxide. Alternatively, the particle diameters of the titanium oxide and the oxide of ruthenium can be essentially equal. The titanium oxide can be a modified titanium oxide doped with a dopant, such as one or both of niobium and tantalum.

Alternatively, a modified titanium oxide can be used. The modified titanium oxide is obtained by doping titanium oxide with a dopant such as niobium and tantalum. One or more dopants can be used. The modified titanium oxide is more conductive than the unmodified titanium oxide, and contributes conductivity to the catalyst layer.

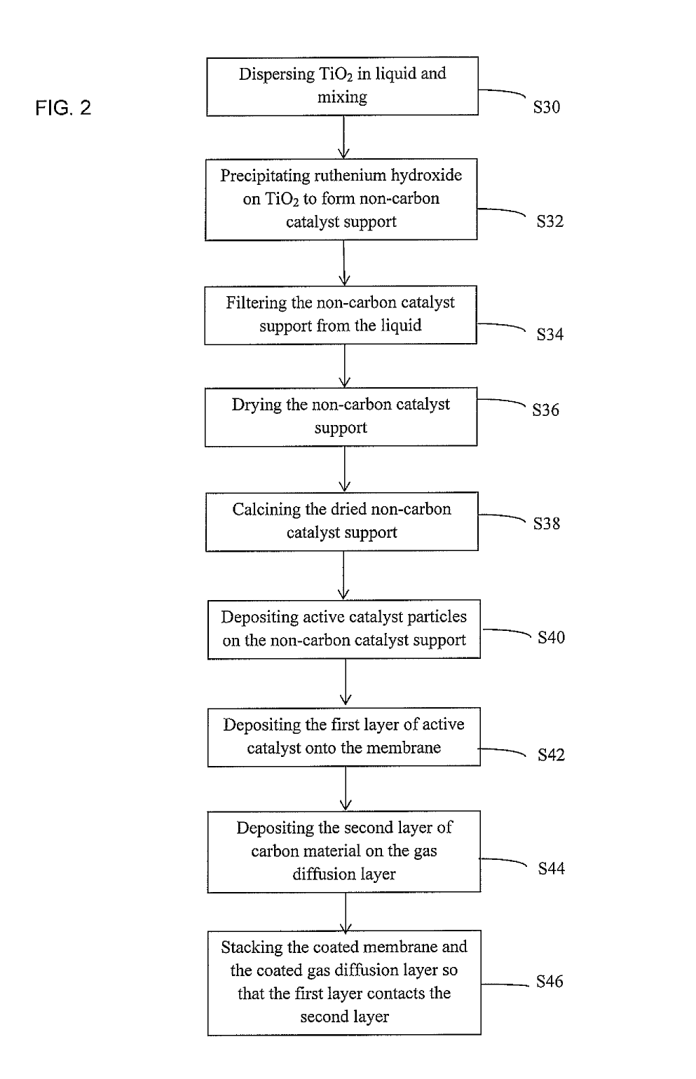

As shown in FIG. 2, an illustrative example of a method of preparing an embodiment of the membrane electrode assembly 10 disclosed herein comprises dispersing titanium dioxide nanopowder in liquid and mixing for a first period of time in step S30. In step S32, ruthenium hydroxide is precipitated on the titanium dioxide nanopowder to form non-carbon metal oxide support particles 18 consisting essentially of titanium dioxide and ruthenium dioxide. The non-carbon metal oxide support particles 18 are filtered from the liquid in step S34 and dried in step S36. The dried non-carbon metal oxide support particles 18 can be calcined in step S38, at 450° C., for example. Precious metal active particles 20 are deposited on the non-carbon metal oxide support particles 18 in step S40 by reducing an active catalyst precursor with acid. The precious metal active particles 20 can be platinum particles, as a non-limiting example. In step S42, the active catalyst is deposited onto a membrane 12 to form the first layer 14. The second layer 22 is formed on the gas diffusion layer 26 in step S44, and the membrane 12 and gas diffusion layer 26 are stacked with the first and second layers 14, 22 contacting one another in step S46.

Alternatively, the second layer 22 can be formed on the first layer 14 after the first layer 14 has been deposited onto the membrane 12. The gas diffusion layer 26 can then be pressed onto the second layer 22 to form the membrane electrode assembly 10.

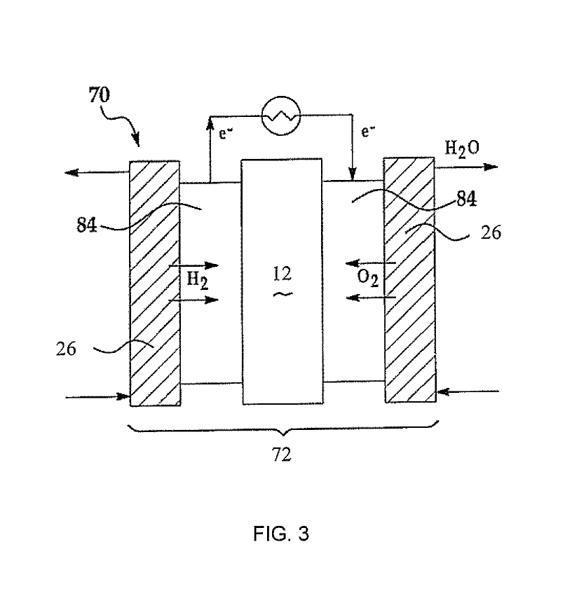

FIG. 3 illustrates the use of the membrane electrode assemblies disclosed herein in a fuel cell electrode. FIG. 3 is a schematic of a fuel cell 70, a plurality of which makes a fuel cell stack. The fuel cell 70 is comprised of a single membrane electrode assembly 72. The membrane electrode assembly 72 has a membrane 80 and a gas diffusion layer 82, with each active material layer 84 comprising the first layer 14 and second layer 22 as disclosed, with the active material layer 84 on opposing sides of the membrane 80. When fuel, such as hydrogen gas (shown as H₂), is introduced into the fuel cell 70, the active material layer 84 having the first layer 14 and the second 22 splits hydrogen gas molecules into protons and electrons. The protons pass through the membrane 80 to react with the oxidant (shown as O₂), such as oxygen or air, forming water (H₂O). The electrons (e⁻), which cannot pass through the membrane 80, must travel around it, thus creating the source of electrical energy.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A membrane electrode assembly comprising:
a membrane;
a first layer contacting the membrane and consisting essentially of catalyst particles comprising non-carbon metal oxide support particles and precious metal particles deposited on the non-carbon metal oxide support particles;
a second layer of carbon particles on the first layer; and
a gas diffusion layer in contact with the second layer.

2. The membrane electrode assembly of claim 1, wherein the carbon particles are activated carbon particles.

3. The membrane electrode assembly of claim 1, wherein the carbon particles are carbon black.

4. The membrane electrode assembly of claim 1, wherein the second layer further comprises an ionomer mixed with the carbon particles.

5. The membrane electrode assembly of claim 1, wherein the second layer further comprises polytetrafluoroethylene mixed with the carbon particles.

6. The membrane electrode assembly of claim 1, wherein the precious metal particles are platinum.

7. The membrane electrode assembly of claim 1, wherein the non-carbon metal oxide support particles comprise a non-conductive metal oxide and a conductive metal oxide.

8. The membrane electrode assembly of claim 7, wherein the non-conductive metal oxide is titanium dioxide and the conductive metal oxide is ruthenium oxide.

9. The membrane electrode assembly of claim 8, wherein the ruthenium oxide is one or both of ruthenium dioxide and ruthenium tetroxide.

10. The membrane electrode assembly of claim 8, wherein the ruthenium oxide is deposited onto the titanium dioxide to form the non-carbon metal oxide support particles.

11. The membrane electrode assembly of claim 8, wherein the titanium dioxide is a modified titanium dioxide doped with a dopant.

12. A composite catalyst for a membrane electrode assembly comprising:
a first layer configured to contact a membrane of the membrane electrode assembly, the first layer consisting essentially of catalyst particles comprising non-carbon metal oxide support particles of titanium dioxide and oxides of ruthenium, and precious metal particles deposited on the non-carbon metal oxide support particles; and
a second layer contacting the first layer and configured to be positioned between the first layer and a gas diffusion layer of the membrane electrode assembly, the second layer comprising carbon particles.

13. The composite catalyst of claim 12, wherein a thickness of the first layer is determined based catalyst activity requirements and a concentration of the oxides of ruthenium, and a thickness of the second layer is determined to optimize a total thickness of an electrode catalyst layer.

14. The composite catalyst of claim 12, wherein the carbon particles are activated carbon particles.

15. The composite catalyst of claim 12, wherein the carbon particles are carbon black.

16. The composite catalyst of claim 12, wherein the second layer further comprises an ionomer mixed with the carbon particles.

17. The composite catalyst of claim 12, wherein the second layer further comprises polytetrafluoroethylene mixed with the carbon particles.

18. The composite catalyst of claim 12, wherein the precious metal particles are platinum.

19. The composite catalyst of claim 12, wherein the titanium dioxide is a modified titanium dioxide doped with a dopant.

20. The composite catalyst of claim 19, wherein the dopant is one of both of niobium and tantalum.
